(19) United States
(12) Patent Application Publication
(10) Pub. No.: US 2025/0079650 A1
(43) Pub. Date: Mar. 6, 2025

(54) LEAD TAB MANUFACTURING APPARATUS AND MANUFACTURING METHOD FOR SECONDARY BATTERY

(71) Applicant: NSM CO., LTD., Cheongju-si (KR)

(72) Inventors: Min Gou HAN, Cheongju-si (KR); Yang Hoon PARK, Cheongju-si (KR)

(21) Appl. No.: 18/819,303

(22) Filed: Aug. 29, 2024

(30) Foreign Application Priority Data
Sep. 1, 2023 (KR) 10-2023-0116367

(51) Int. Cl. H01M 50/533; H01M 50/145

(52) U.S. Cl. CPC H01M 50/533; H01M 50/145

(57) ABSTRACT

An apparatus for manufacturing a lead tab for a secondary battery may include a marking unit configured to define a processing pattern on a processing area set on each of an upper surface and a lower surface of an original sheet of the lead tab or the lead tabs; and a stabilization unit configured to provide an oxidation film to the upper and lower surfaces of the original sheet of the lead tab or each of the lead tabs, the upper and lower surfaces having the processing pattern defined thereon, respectively, by applying heat with a certain temperature or above to each of the original sheet of the lead tab or the lead tabs having the processing pattern defined on the upper and lower surfaces, respectively.

### BACKGROUND OF THE INVENTION

### Field of the Invention

The present disclosure relates to an apparatus and a method for manufacturing a lead tab used for a secondary battery.

### Background of the Related Art

Generally, secondary batteries are batteries capable of being used repeatedly through a discharging process of converting chemical energy into electrical energy and a charging process of converting electrical energy into chemical energy. Secondary batteries may include nickel-cadmium (Ni—Cd) batteries, nickel-metal hydride (Ni-MH) batteries, lithium-metal batteries, lithium-ion (Ni-Ion) batteries, lithium-ion polymer batteries, etc.

Among secondary batteries, lithium secondary batteries have a cycle life of about 500 times or more and a short charging time of about 1 to 2 hours. The lithium secondary batteries are about 30 to 40% lighter than nickel-hydrogen batteries, allowing weight reduction. Among existing secondary batteries, the lithium secondary batteries have a highest voltage per unit cell (3.0 to 3.7 V) and excellent energy density. Thus, the lithium secondary batteries may have characteristics optimized for mobile devices.

The lithium secondary batteries may include an electrode assembly accommodated in a battery case, a lead tab electrically connected to electrode tabs of electrodes included in the electrode assembly and drawn out of the battery case, and a sealant film (an insulating film) configured to electrically insulate the lead tab.

Particularly, the sealant film may have one surface fused to the lead tab and another surface fused to the electrode case, the another surface being opposite to the one surface, to be capable of performing a function of sealing an interface between the lead tab and the electrode case.

However, since the lead tab is made of a material different from that of the sealant film, there is a limit in securely fusing the sealant film to the lead tab. Additionally, in the prior art, when the electrolyte contained within the pouch of the secondary battery cell penetrates through the gap between the lead tabs and the sealant film, there may be instances where the contact surface of the lead tabs corrodes, causing issues in maintaining a stable adhesion between the lead tabs and the sealant film.

Accordingly, the present applicant proposes a technology related to manufacture of lead tabs to be capable of further improving adhesiveness between the lead tab and the sealant film and maximizing productivity by reducing occurrence of defects when the lead tab is manufactured.

### PRIOR ART DOCUMENTS

### Patent Documents

(Patent Document 1) Korea Patent Publication No. 10-1586072 (registered on Jan. 11, 2016)

### SUMMARY OF THE INVENTION

Therefore, the present disclosure has been made in view of the above problems, and it is an object of the present disclosure to provide an apparatus and a method for manufacturing a lead tab for a secondary battery, the apparatus and the method being configured such that a laser is used to perform surface treatment work on a lead tab to have great positional precision, as well as to stably maintain a state of adhesion to a sealant film without corrosion even when in contact with an electrolyte of a secondary battery cell.

To accomplish the above object, according to one aspect of the present disclosure, there is provided an apparatus configured to manufacture a lead tab for a second battery, the apparatus including: a marking unit configured to define a processing pattern on a processing area set on each of an upper surface and a lower surface of an original sheet of the lead tab or the lead tabs; and a stabilization unit configured to provide an oxidation film to the upper and lower surfaces of the original sheet of the lead tab or each of the lead tabs, the upper and lower surfaces having the processing pattern defined thereon, respectively, by applying heat with a certain temperature or above to each of the original sheet of the lead tab or the lead tabs having the processing pattern defined on the upper and lower surfaces, respectively.

The apparatus may further comprise a post-processing unit configured to cool each of the sheet-shaped lead tabs on which the oxidation film is provided.

THE stabilization unit may include: a stabilization body equipped with a hot air injection plate at one side, the hot air injection plate having a plurality of hot air injection holes disposed therein; a heater mounted in the stabilization body; at least one air flow path disposed in the stabilizing body and configured to define a path to cause compressed air provided from outside to flow toward the plurality of hot air injection holes; and a plurality of heat conductive balls accommodated in the at least one air flow path and made of a heat-conductive material.

The plurality of heat conductive balls may be made of an alumina or copper material.

A flow cap may be installed in the at least one air flow path, the flow cap being configured to limit an area of the at least one air flow path in which the plurality of heat conductive balls are accommodated and prevent the flowing of the compressed air from being interrupted by the plurality of heat conductive balls.

The hot air injection plate may be arranged to be in direct contact with the upper and lower surfaces of the original sheet of the lead tab or each of the lead tabs, the upper and lower surfaces having the processing pattern defined thereon.

The post-processing unit may cool the upper and lower surfaces of the original sheet of the lead tab or each of the lead tabs by blowing low-temperature air onto the upper and lower surfaces or by injecting water having a low temperature to the upper and lower surfaces.

The post-processing unit may cool the upper and lower surfaces of the original sheet of the lead tab or each of the lead tabs by bringing a cooling body having a low temperature in contact with the upper and lower surfaces.

To accomplish the above object, according to another aspect of the present disclosure, there is also provided a method for manufacturing a lead tab for a second battery, the method including: a) supplying an original sheet of the lead tab or the lead tabs; (b) defining a processing pattern on each of an upper surface and a lower surface of the original sheet of the lead tab or each of the lead tabs by radiating laser light to a processing area set on each of the upper surface and the lower surface; (c) providing an oxidation film to the upper and lower surfaces on which the processing pattern is defined, by applying heat with a certain temperature or above to the original sheet of the lead tab or each of the lead tabs having the processing pattern defined on the upper and lower surfaces, respectively.

Operation (a) may include unwinding and supplying an original sheet of the lead tab wound in a roll state or cutting the original sheet of the lead tab continuously supplied, at intervals, to be divided into sheet-shaped lead tabs and supplying the sheet-shaped lead tabs.

The method may further include (d) after operation (c), cooling the original sheet of the lead tab or each of the sheet-shaped lead tabs on which the oxidation film is provided.

Operation (c) may be performed by a hot air injection plate being arranged to be in direct contact with the upper and lower surfaces of the original sheet of the lead tab or each of the lead tabs, wherein the hot air injection plate provides heat at a temperature above a certain level to the upper and lower surfaces having the processing pattern defined thereon.

Operation (d) may include blowing low-temperature air or spraying water at low temperature onto the surface of the original sheet of the lead tab or each of the lead tabs to cool.

Operation (d) may include contacting the surface of the original sheet of the lead tab or each of the lead tabs with a cooling body having a low temperature to cool.

According to the apparatus and the method for manufacturing a lead tab for a secondary battery in the present disclosure described above, an oxidation film may be provided by applying heat having a high temperature to portions of the upper surface processing pattern and the lower surface processing pattern. Thus, occurrence of corrosion may be prevented even when an electrolyte contained in a secondary battery cell pouch penetrates into a gap between the upper surface processing pattern/lower surface processing pattern and the sealant film. Thus, a stable adhesion state between the sheet-shaped lead tabs and the sealant film may be maintained.

In addition, when an upper surface processing pattern and a lower surface processing pattern are defined to improve adhesion with a sealant film, laser light is not radiated to an original sheet of a lead tab unwound from the supply roll and having a great length, but to set areas of sheet-shaped lead taps obtained by pre-cutting to have a set length. Thus, positional precision of the upper surface processing pattern and the lower surface processing pattern may be further enhanced.

In addition, a process of cooling the sheet-shaped lead tabs to a certain temperature or below may be performed before injecting a liquid adhesive material. Thus, when a process of injecting a liquid adhesive material on a surface of each of the sheet-shaped lead tabs is performed, the liquid adhesive material may not be evaporated but may be in a stably applied state.

In addition, radiation of ultraviolet rays and blowing of hot air may be performed simultaneously, thereby allowing a curing and drying process of a polyvinyl alcohol (PVA) adhesive aqueous solution to proceed quickly.

### BRIEF DESCRIPTION OF THE DRAWINGS

FIG. 1 is a flowchart sequentially showing a method of manufacturing a lead tab for a secondary battery according to an embodiment of the present disclosure.

FIGS. 2 to 4 are diagrams sequentially illustrating a process of manufacturing a lead tab through the method for manufacturing a lead tab for a secondary battery according to an embodiment of the present disclosure.

FIG. 5 is a diagram illustrating radiation of laser light on an original sheet of a lead tab unwound from a supply roll.

FIG. 6 is a diagram illustrating another embodiment of defining an oxidation film in the method for manufacturing a lead tab for a secondary battery according to an embodiment of the present disclosure.

FIG. 7 is a cross-sectional view of a stabilization unit of an apparatus configured to manufacture a lead tab for a secondary battery according to an embodiment of the present disclosure.

FIG. 8 is an exploded perspective view of the stabilization unit of the apparatus configured to manufacture a lead tab for a secondary battery according to an embodiment of the present disclosure.

FIG. 9 is a cutaway perspective view of a flow cap in the stabilization unit of the apparatus configured to manufacture a lead tab for a secondary battery according to an embodiment of the present disclosure.

FIGS. 10 and 11 are diagrams schematically illustrating a curing and drying unit of the apparatus configured to manufacture a lead tab for a secondary battery according to an embodiment of the present disclosure.

FIG. 12 is a top view illustrating an arrangement relationship between a hot-air drying unit and the curing and drying unit of the apparatus configured to manufacture a lead tab for a secondary battery according to an embodiment of the present disclosure.

### DETAILED DESCRIPTION OF THE PREFERRED EMBODIMENT

Hereinafter, an embodiment of the present disclosure will be described in detail with reference to the accompanying drawings. However, the present disclosure is not limited to the embodiments set forth herein, and may be embodied in many different forms. The embodiments are provided so that this disclosure will be thorough and complete, and will fully convey the concept of the present disclosure to those skilled in the art, and the scope of the present disclosure should be defined by the appended claims. Like reference numerals in the drawings denote like elements.

An apparatus and a method for manufacturing a lead tab for a secondary battery according to an embodiment of the present disclosure may allow to have precise positioning accuracy when surface treatment is performed on a lead tab using a laser, and also stably maintain a state of adhesion of the lead tab to a sealant film without corrosion even when in contact with an electrolyte of a secondary battery cell. Here, the sealant film is interposed between the lead tab and a pouch of a secondary battery cell to function as a seal to prevent leakage of the electrolyte as well as to perform electrical insulation. A detailed description thereof is obvious to one of ordinary skill in the art to which the present disclosure belongs, and thus, will not be provided here.

Hereinafter, the present disclosure will be described in detail with reference to an embodiment.

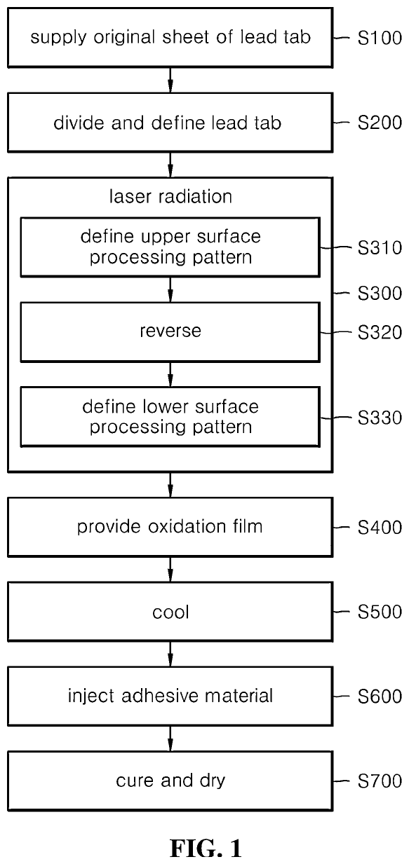

As illustrated in FIG. 1, the method for manufacturing a lead tab for a secondary battery according to an embodiment of the present disclosure includes supplying an original sheet of a lead tab (S100), dividing and defining the lead tab (S200), laser irradiation (S300), defining an oxidation film (S400), cooling (S500), injecting an adhesive material (S600), and curing and drying (S700).

Below, prior to the detailed description, in the method for manufacturing a lead tab for a second battery, according to an embodiment of the present disclosure, operation S400 provides an oxidation film 401 to the upper and lower surfaces on which the processing pattern is defined, by applying heat with a certain temperature or above to the original sheet 100 of the lead tab or each of the lead tabs 110 having the processing patterns 310,320 defined on the upper and lower surfaces, respectively.

That is, operation S300 defines a processing pattern on each of an upper surface and a lower surface of the original sheet of the lead tab or each of the lead tabs by radiating laser light to a processing area set on each of the upper surface and the lower surface, and S400 may provide an oxidation film 401 to the upper and lower surfaces on which an upper and a lower surface processing patterns 310, 320 is defined, by applying high-temperature heat to the original sheet 100 of the lead tab or each of the lead tabs 110 having the processing patterns 310,320 defined on the upper and lower surfaces, respectively.

In this way, the object to form the oxidation film may be the original sheet of the lead tab or the lead tabs in the form of sheets that are obtained by cutting the original sheet of the lead tab to a set length.

Hereinafter, for the convenience of explanation and illustration, the formation of an oxidation film on sheet-shaped lead tabs will be described and illustrated as an example. It should be noted that when applied to the original sheet 100 of the lead tab, only the object changes, but the same post-processing operations with the sheet-shaped lead tabs may be applied to the original sheet 100 of the lead tab.

First, an original sheet 100 of a lead tab wound in a roll state is unwound and continuously supplied to a post-processing stage (S100).

When wound on a supply roll 101, the original sheet 100 of the lead tab is unwound from the supply roll 101 by a rotation of the supply roll 101.

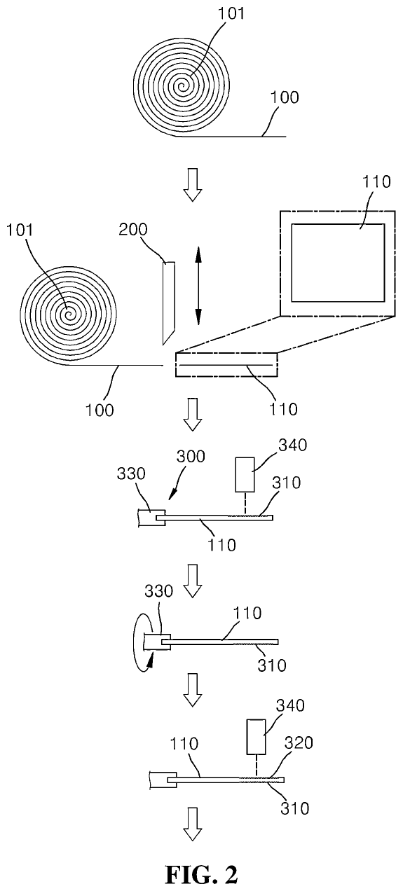

Then, the original sheet 100 of the lead tab being continuously supplied is cut at intervals to be divided into lead tabs 110 having a sheet shape (S200). Here, as illustrated in FIG. 2, cutting of the original sheet 100 of the lead tab may be performed through a cutting unit 200 by a blade moving longitudinally from an upper side to a lower side in a state when a lower part of the original sheet 100 of the lead tab is partially supported. In detail, the cutting unit 200 may include a blade in contact with the original sheet 100 of the lead tab to perform cutting, a transfer member (not shown) configured to reciprocatively move the blade to be close to or apart from the original sheet 100 of the lead tab, and at least one clamp (not shown) configured to fix a cut portion of the original sheet 100 of the lead tab when the original sheet 100 of the lead tab is cut by the blade.

Then, laser light is radiated to a processing area set on each of upper and lower surfaces of the lead tabs 110 to define a processing pattern on each of the upper and lower surfaces (S300).

In an embodiment of the present disclosure, as illustrated in FIG. 2, operation S300 is performed through a marking unit 300 configured to define the processing pattern on each of the upper and lower surfaces by radiating laser light to the processing area set on the upper and lower surfaces of the lead tabs 110 having a sheet shape.

Here, operation S300 includes defining an upper surface processing pattern 310 by radiating laser light to the upper surfaces of the lead tabs 110 (S310), reversing upside down the lead tabs 110 each on which the upper surface processing pattern 310 is defined (S320), and defining a lower surface processing pattern 320 by radiating laser light to the lower surfaces of the lead tabs 110 which have been reversed upside down (S330).

In an embodiment of the present disclosure, operations S310 and S330 are performed by radiating laser light in a downward direction from above the lead tabs 110 toward the lead tabs 110.

Meanwhile, when the upper surface processing pattern 310 and the lower surface processing pattern 310 each configured in various shapes of groove such as a continuous straight line, a dot, or a grid are defined on a surface of a lead tab having a metal material through laser radiation, as high-temperature laser light is radiated to the lead tab, metal vapor condenses on a corresponding part of the lead tab, thus generating laser fumes in a form of dust.

In a process of performing work through the laser irradiation, a phenomenon in which the laser fumes in a form of dust particles fall downward and adhere to a surface of a laser radiation lens (not shown) configured to perform laser radiation among various components constituting the marking unit 300 may occur. In this case, such a disadvantage that the surface of the laser irradiation lens needs to be cleaned periodically, and in severe cases, a problem such as molding defects may occur. In addition, when a process of cleaning the laser irradiation lens is added, such overall product productivity may deteriorate due to the addition of the cleaning process.

To compensate for this, in operations S310 and S330, the laser radiation is performed by radiating laser light in a downward direction from above the lead tabs 110 toward the lead tabs 110. Thus, occurrence of the phenomenon in which the laser fumes adhere to a surface of the laser irradiation lens as described above may be effectively prevented.

In the apparatus configured to manufacture a lead tab for a secondary battery according to an embodiment of the present disclosure, the marking unit 300 includes a lead tab reversing portion 330 and a marking portion 340 as shown in FIG. 2.

The lead tab reversing portion 330 is configured to grip or ungrip the lead tabs 110 defined as being divided into individual units of a sheet by the cutting unit 200. As an example, the lead tab reversing portion 330 may include a pneumatic cylinder, a gripper connected to the pneumatic cylinder to grip the lead tab 110, a motor capable of ultimately reversing the lead tabs 110 upside down by 180 degrees by rotating the pneumatic cylinder or the gripper, etc.

In an embodiment of the present disclosure, the lead tab reversing portion 330 further includes a separate reciprocating movement element (not shown) capable of causing the pneumatic cylinder, the gripper, and the motor, etc. to reciprocate between the cutting unit 200 and an area in which the marking unit 340 is installed so that a lead tap cut by the cutting unit 200 is gripped, and then, move to the area in which the marking unit 340 to be described later is installed.

As illustrated in FIG. 2, the marking unit 340 defines the upper surface processing pattern 310 by radiating laser light to the upper surfaces of the lead tabs 110, and, in a state when the lead taps 110 are rotated by the lead tap reversing portion 330 to be reversed upside down, defines the lower surface processing pattern 320 by radiating laser light to the lower surface of the lead taps 110.

In an embodiment of the present disclosure, the marking portion 340 is disposed to radiate laser light in a downward direction from above the lead taps 110 toward the lead taps 110. Accordingly, as described above, detective processing and deterioration in productivity due to adhesion of laser fumes to a surface of a laser irradiation lens may be effectively prevented.

The marking portion 340 includes a laser oscillator (not shown) configured to generate laser light and oscillate, a laser scanner (not shown) configured to radiate the laser light transmitted from the laser oscillator to predetermined scan areas on the upper and lower surfaces of the lead tabs 110, and a laser scanner driver (not shown) configured to reciprocatively transfer the laser scanner along a width direction of the lead tabs 110.

In the present disclosure, when an upper surface processing pattern and a lower surface processing pattern are defined to improve adhesion with a sealant film, laser light is not radiated to the original sheet 100 of the lead tab unwound from the supply roll 101 and having a great length, but to set areas of the lead taps 110 obtained by pre-cutting to have a sheet shape in a set length. Thus, positional precision of the upper surface processing pattern 310 and the lower surface processing pattern 320 may be further enhanced.

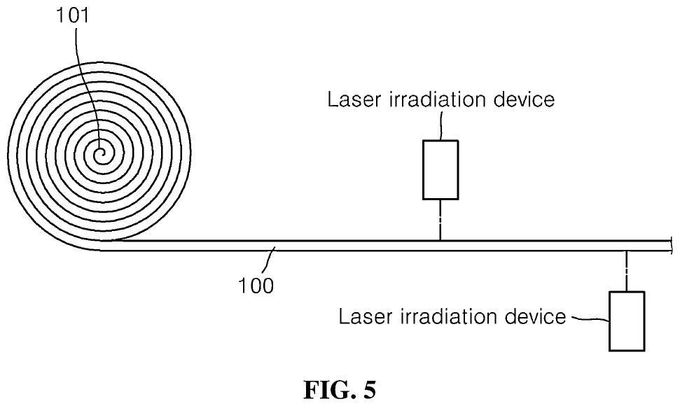

In other words, unlike a case implemented in the present disclosure, when upper and lower surface processing patterns are defined by radiating laser light to the original sheet 100 of the lead tab unwound from the supply roll 101 and having a great length at intervals along a lengthwise direction as illustrated in FIG. 5, a high temperature may be generated on the original sheet 100 of the lead tap due to the radiation of the laser light, and thus, a phenomenon in which the original sheet 100 of the lead tap is thermally expanded (stretched) along the lengthwise direction may occur due to the generation of the high temperature.

In addition, in a process of unwinding the original sheet 100 of the lead tab wound in a roll shape, a tensile force at a certain level or above is applied to the original sheet 100 of the lead tab in a lengthwise direction. In a state of the application of the tensile force, as high temperature heat is exerted through laser radiation, a phenomenon in which the original sheet 100 of the lead tab is thermally expanded (stretched) along a lengthwise direction may occur.

As such, in a process of transferring an original sheet of a lead tab in an expanded state in a lengthwise direction to a certain degree or more, even when a laser irradiation device installed at a predetermined location to radiate laser light toward the original sheet of the lead tab periodically radiates laser light to define a plurality of upper and lower surface processing patterns, spaces between the plurality of upper and lower surface processing patterns may not be constantly maintained.

That is, even when laser light is radiated periodically at a set interval on the original sheet of the lead tab being transferred, the spaces between the plurality of upper and lower processing patterns defined on the original sheet of the lead tab may not be constantly disposed due to the thermal expansion of the original sheet of the lead tab in a lengthwise direction. Accordingly, afterwards, when the original sheet of the lead tab is cut to obtain lead tabs in individual units of a sheet shape, positions of the upper and lower surface processing patterns defined on individual lead tabs are not identical to each other, thus causing occurrence of defects.

However, in the present disclosure, laser light is not radiated to the original sheet 100 of a lead tab unwound from the supply roll 101 and having a great length to define upper and lower surface processing patterns, but dividing through the cutting unit 200 is performed to obtain the lead tabs 110 having a sheet shape with a unit length, and then, laser light is radiated to upper and lower surfaces of the lead tabs 110. Thus, deterioration in positional precision as described above may be prevented.

That is, cutting is performed to obtain the lead tabs 110 to have a length of approximately 30 to 80 mm, and then, laser light is radiated to the obtained lead tabs 110. Thus, compared to when laser light is radiated to an original sheet of a lead tab having a great length, occurrence of thermal expansion of the lead tabs 100 in a lengthwise direction may be prevented. Accordingly, upper and lower surface processing patterns may be accurately defined to a desired location on the upper and lower surfaces of the lead tabs 110.

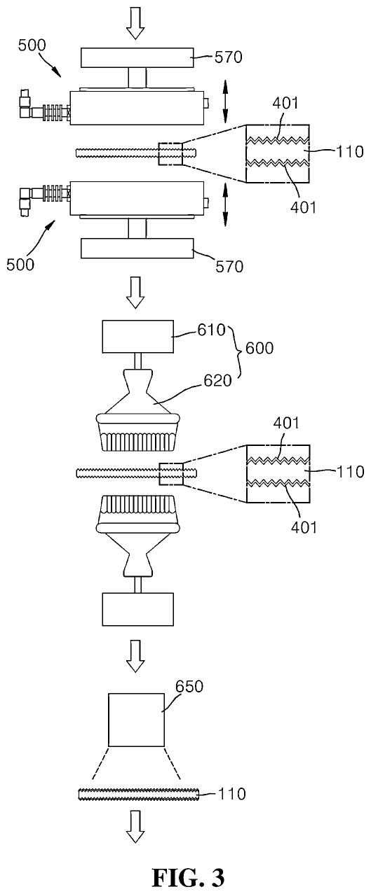

As illustrated in FIGS. 1 and 3, the method for manufacturing a lead tab for a secondary battery according to an embodiment of the present disclosure further includes, after operation S300, providing an oxidation film 401 to surfaces on which the upper and lower processing patterns 310 and 320 are defined, respectively, by applying heat with a certain temperature or above to the lead tabs 110 having the upper and lower surface processing patterns 310 and 320 defined on the upper and lower surfaces, respectively (S400), and cooling the lead tabs 110 on which the oxidation film 401 is provided (S500).

In addition, the method for manufacturing a lead tab for a secondary battery according to an embodiment of the present disclosure further includes, after operation S500, injecting a liquid adhesive material on a surface of the oxidation film 401 (S600) and curing and drying the liquid adhesive material (S700).

When respective operations are sequentially described, in operation S400, the oxidation film 401 is provided on surfaces of the lead tabs 110 made of a metal material such as copper or nickel-plated copper, in detail, on a surface on which the upper surface processing pattern 310 and the lower surface processing pattern 320 are defined.

In detail, as an example, in operation S400, the oxidation film 401 including copper oxide may be provided by applying high temperature heat and hot air of approximately 300 to 350° C. to the surfaces of the lead tabs 100 made of a copper material.

The oxidation film 401 may improve corrosion resistance by preventing oxidation (corrosion) of the surfaces of the lead tabs 110 by stabilizing the surfaces of the lead tabs 110 on which the upper surface processing pattern 310 and the lower surface processing pattern 320 are defined. Thus, occurrence of corrosion may be prevented even when an electrolyte contained in a secondary battery cell pouch penetrates into a gap between the upper surface processing pattern 310/lower surface processing pattern 320 and the sealant film 402. Thus, a stable adhesion state between the lead tabs 110 and the sealant film 402 may be maintained.

Then, in operation S500, the lead tabs 110 on which the oxidation film 401 is defined is cooled.

As described above, as high temperature heat and hot air are applied to the lead tabs 110 to provide the oxidation film 401, a considerably high temperature may also be generated on surfaces of the lead tabs 110.

Meanwhile, in operation S600 to be described later, a liquid adhesive material is injected as an adhesive to a surface of the oxidation film 401 to attach the sealant film 402 to portions of the upper and lower surface processing patterns 310 and 320 of the lead tabs 110. Operation S500 is performed before the injecting of the liquid adhesive.

In a state in which the process of cooling a lead tab as described with reference to operation S500 is not performed, that is, in a state in which heat and hot air of an excessively high temperature are applied to the lead tabs 110 to define the oxidation film 401, when a liquid adhesive material is injected to the lead tabs 110 immediately without the cooling process, there may be a problem such that the liquid adhesive material is not maintained in a state of being applied to the surfaces of the lead tabs 110, but is immediately evaporated. To prevent occurrence of such a problem, in the present disclosure, a process of cooling the lead tabs 110 to a certain temperature or below may be performed before the injection of the liquid adhesive material. Thus, when a process of injecting a liquid adhesive material to the surfaces of the lead tabs 110 is performed, the liquid adhesive material may not be evaporated but may be in a stably applied state.

As illustrated in FIG. 3, the apparatus configured to manufacture a lead tab for a secondary battery according to an embodiment of the present disclosure includes a stabilization unit 500 configured to provide the oxidation film 401 to surfaces on which the upper surface processing pattern 310 and the lower surface processing pattern 320 are defined, respectively, by applying heat with a certain temperature or above to the lead tabs 110 having the upper and lower surface processing patterns 310 and 320 defined on the upper and lower surfaces, respectively, and a post-processing unit 600 configured to cool the lead tabs 110 on which the oxidation film 401 is provided.

In an embodiment of the present disclosure, as one example, the stabilization unit 500 may be disposed to be capable of being in direct contact with surfaces of the lead tabs 110. Thus, conduction heat may be transmitted through the direct contact to provide high temperature to the surfaces of the lead tabs 110 to thereby provide the oxidation film 401.

In addition, as another example, the stabilization unit 500 may be disposed to be apart from the surfaces of the lead tabs 110 by a certain distance to provide high temperature to the surfaces of the lead tabs 110 through a non-contact radiant heat transfer to thereby provide the oxidation film 401.

Hereinafter, for convenience of illustration, a case when the stabilization unit 500 may be disposed to be apart from a surface of a lead tab 110 by a certain distance to provide high temperature to the surface of the lead tab 110 through a non-contact radiant heat transfer is illustrated in the relevant drawings as an example.

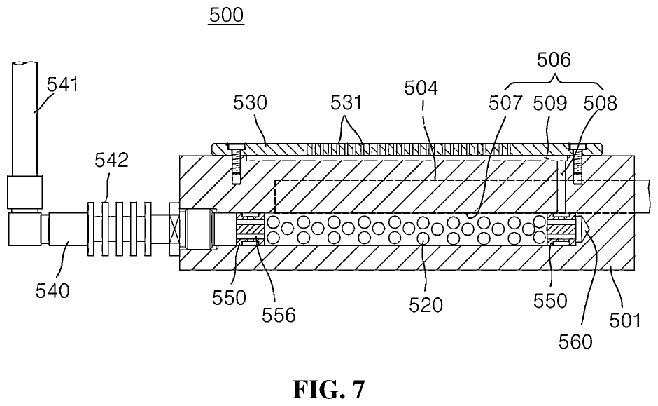

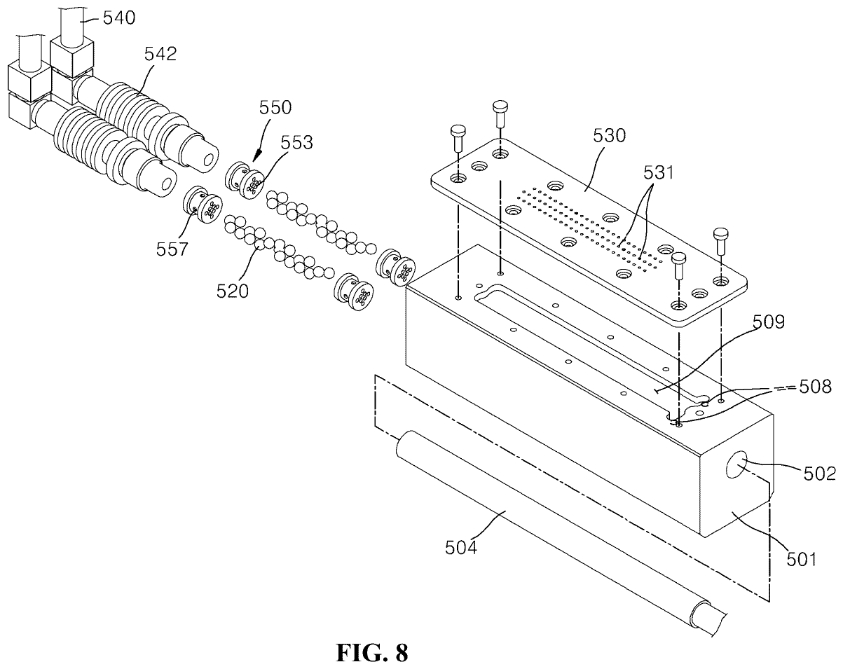

As shown in FIGS. 7 to 9, the stabilization unit 500 includes a stabilization body 501, a heater 504, an air flow path 506, and a heat conductive ball 520.

The stabilization body 501 is made of a metal material, and has a heater insertion hole 502 disposed inside so that the heater 504 is inserted therein. A hot air injection plate 530 having a plurality of hot air injection holes 531 therein is disposed at one side of the stabilization body 501. The hot air injection plate 530 is coupled to the stabilization body 501 to cover a third air flow path 509 to be described later and seal the third air flow path 509 from outside, and is detachably coupled to the stabilization body 501 using a screw, etc.

The heater 504 is inserted into the heater insertion hole 502, and when power is supplied from outside, the heater 504 generates heat at a high temperature, thereby causing a temperature of the stabilization body 501 made of a metal material to rise to a high temperature.

At least one air flow path 506 is disposed in the stabilization body 501 and defines a path so that compressed air provided from outside flows toward the plurality of hot air injection holes 531.

In detail, as illustrated in FIGS. 7 to 9, the at least one air flow path 506 includes a plurality of first air flow path 507 disposed to have a length along a lengthwise direction of the stabilization body 501 and spaced apart from each other, a plurality of second air flow paths 508 in communication with an end portion at one side of the plurality of first air flow paths 507, respectively, and extending toward an edge of the stabilization body 50, and a third air flow path 509 concavely disposed on an outer surface of the stabilization body 501 to communicate with the plurality of second air flow paths 508 and exposed to outside when the hot air injection plate 530 is detached from the stabilization body 501.

That is, the third air flow path 509 is disposed to be concave on the outer surface of the stabilization body 501 to be covered by the hot air injection plate 530 and blocked from being exposed to outside when the hot air injection plate 530 is coupled to one side surface of the stabilization body 501, and to be exposed to outside when the hot air injection plate 530 is detached from the one side surface of the stabilization body 501. A separate sealing material (not shown) may be provided between the stabilization body 501 and the hot air injection plate 530 to prevent high-temperature compressed air from being leaked to a portion other than the hot air injection holes 531.

In an embodiment of the present disclosure, an air supply socket 540 made of a metal material is coupled to another side of the plurality of first air flow paths 507 to supply high-pressure compressed air from outside into the first air flow paths 507. In detail, screw threads are disposed on a part of an inner circumferential surface of the first air flow paths 507, and screw threads configured to be screwed thereto correspondingly are disposed on an outer surface of the air supply socket 540. Accordingly, the air supply socket 540 is detachably coupled to the stabilization body 501 through screw coupling.

An air flow path may be disposed inside the air supply socket 540, and an air hose 541 made of rubber may be connected to one side of the air flow path to be connected to an air compressor, etc.

Meanwhile, due to heat generation from the heater 504, a considerably high temperature is developed not only in the stabilization body 501 but also in the air supply socket 540 coupled to the stabilization body 501. When a certain amount of such high temperature heat or more is transferred to the air hose 541, a phenomenon in which the air hose 541 melts and is damaged may occur. Thus, in an embodiment of the present disclosure, a heat dissipation fin 542 is disposed to prevent heat developed in the stabilization body 501 from being transferred to the air hose 541 through the air supply socket 540 as possible.

A plurality of heat dissipation fin 542 are disposed on one side portion of the air supply socket 540 adjacent to the stabilization body 501 to release heat into atmosphere. By doing so, heat transferred to the air hose 541 may be reduced, and thus, the air hose 541 may be prevented from melting or being damaged, thereby ultimately increasing durability.

The heat conductive ball 520 may be disposed in plurality, and the plurality of heat conductive ball 520 are accommodated in the at least one air flow path 506, i.e., a first air flow path 507 and made of a thermally conductive material.

In an embodiment of the present disclosure, the plurality of heat conductive balls 520 may have a diameter of approximately 2 to 5 mm and be made of an alumina or copper material having a certain thermal conductivity or greater.

Accordingly, when a temperature of the stabilization body 501 rises to a high temperature due to heat generation from the heater 504, a temperature of the plurality of heat conducting balls 520 having received heat from the stabilization body 501 also rises to a high temperature.

Meanwhile, high-pressure compressed air having passed through the air hose 541 is introduced into the first air flow paths 507, and then, sequentially passes through the second air flow paths 508, the third air flow path 509, and the hot air injection holes 531 to be injected outside. While flowing along the first air flow paths 507 toward the second air flow paths 508, the high-pressure compressed air flows by further receiving heat from the heat conductive balls 520.

As described above, as the plurality of heat conductive balls 520 are arranged to be filled in the first air flow paths 507 as tightly as possible in a state when a temperature of the plurality of heat conductive balls 520 has risen to a high temperature, an area of contact between high-pressure compressed air and a high-temperature heat dissipation body may be eventually further increased while the high-pressure compressed air is passing through the first air flow paths 507, compared to when the heat conductive balls 520 are not disposed.

That is, when the heat conductive balls 520 are not disposed, compressed air passing through the first air flow paths 507 comes into contact only with an inner wall surface constituting the first air flow paths. However, when the heat conductive ball 520 is disposed, compressed air passing through the first air flow paths 507 comes into contact not only with the inner wall surface constituting the first air flow paths 507 but also with surfaces of the plurality of heat conductive balls 520, thereby flowing toward the second air flow paths 508 by receiving sufficiently high temperature heat.

In an embodiment of the present disclosure, as an area of heat exchange (heat contact) between the plurality of heat conductive balls 520 and high-pressure compressed air is increased, compressed air passing through the first air flow paths 507 may be allowed to flow toward the hot air injection holes 531 without a heat loss in a state of receiving maximum high-temperature heat.

As shown in FIGS. 7 to 9, a flow cap 550 may be installed in the at least one air flow path 506 to limit an area of the at least one air flow path 506 in which the plurality of heat conductive balls 520 are accommodated, as well as to prevent flow of compressed air supplied from outside from being interrupted by the heat conductive balls 520.

In detail, the flow cap 550 is installed in the first air flow paths 507 such that the plurality of heat conductive balls 520 are maintained in surface contact with the first air flow paths 507 to be stably accommodated therein and compressed air having passed through the first air flow paths 507 flows smoothly toward the second air flow paths 508. Here, a pair of flow caps 550 may be disposed to be spaced apart from each other to have the plurality of heat conductive balls 520 arranged in an area therebetween.

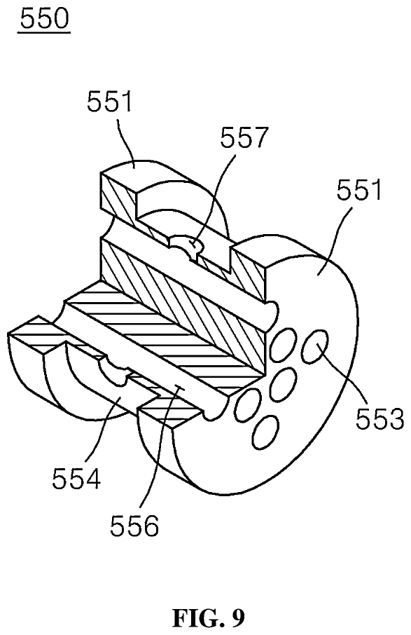

As illustrated in FIG. 9, the pair of flow caps 550 are configured to have a same shape and structure, and each includes a pair of flow cap plates 551 spaced apart from each other and a connecting portion 554 connecting the pair of flow cap plates 551 to each other.

A plurality of first through holes 553 are disposed to penetrate through each of the pair of flow cap plates 551 in a thickness direction. A plurality of second through holes 556 are disposed in the connecting portion 554 so that the plurality of first through holes 553 disposed each in the pair of flow cap plates 551 communicate with each other in a corresponding lengthwise direction.

Additionally, at least one third through hole 557 is disposed in the connecting portion 554 to communicate with at least one of the plurality of second through holes 556 so that compressed air is discharged in a lateral direction of the connecting portion 554 intersecting with a lengthwise direction of the first through holes 553 and the second through holes 556.

In an embodiment of the present disclosure, diameters of the first through holes 553 and the second through holes 556 are configured to be considerably smaller than diameters of the heat conductive balls 520, and the first through holes 553 and the second through holes 556 are arranged in plurality. Thus, even when, for example, one first through hole 553 and one second through hole 556 are blocked by the heat conductive balls 520, as a plurality of other through holes are opened, smooth flow of compressed air may not be disturbed.

As illustrated in FIG. 7, with respect to a flow cap 550 located adjacent to the second air flow paths 508 among the pair of flow caps 550, a separate cover block 560 may be desirably arranged in a flow cap plate 551 located in a position relatively apart from the heat conductive balls 520, among the pair of flow cap plates 551, so that the compressed air having passed through the first air flow paths 507 may flow only toward the third through holes 557 via the plurality of first through holes 553 and the plurality of second through holes 556. The separate cover block 560 may be coupled to an outer surface of the flow cap plate 551 by welding, screwing, etc. so that flow of the compressed air is quickly performed in a set direction.

In an embodiment of the present disclosure, as described above, as the one example, the stabilization unit 500 may be disposed to be capable of being in direct contact with a surface of the lead tab 110. Thus, conduction heat may be transmitted through the direct contact to provide high temperature to a surface of the lead tab 110 to thereby provide the oxidation film 401. In addition, as another example, the stabilization unit 500 may be disposed to be apart from the surface of the lead tab 110 by a certain distance to provide high temperature to the surface of the lead tab 110 through a non-contact radiant heat transfer to provide the oxidation film 401.

In a case of the direct contact described above as the one example, the stabilization unit 500 may be installed so that the hot air injection plate 530 in the stabilization unit 500 is in contact with a surface of the lead tab 110. In this case, as illustrated in FIG. 3, the stabilization unit 500 may further include a stabilization body transfer portion 570 capable of moving the stabilization body 501 to be closer to or away from a lead tap 110 transferred by the lead tab reversing portion 330 to a work area in which a stabilization process is performed, the lead tab reversing portion 330 being configured to function as a kind of gripper to grip the lead tab 110.

The stabilization body transfer portion 570 may be applied as an element capable of linearly moving a subject back and forth, the subject including a cylinder, a gear-rack module, a linear motion (LM) guide, or the like each configured to operate by receiving pneumatic or hydraulic pressure. Accordingly, when a stabilization process is performed with the stabilization unit 500 in direct contact with a surface of the lead tab 110, the stabilization body transfer portion 570 is driven so that the hot air injection plate 530 is in direct contact with a surface on which a processing pattern of the lead tab 110 is defined.

In a case of the non-contact described above as the another example, the stabilization unit 500 may be installed so that the hot air injection plate 530 in the stabilization unit 500 is spaced apart from a surface of the lead tab 110 by a certain distance. Accordingly, when a stabilization process is performed while the stabilization unit 500 is not in contact with the surface of the lead tab 110, the stabilization body transfer portion 570 is driven so that the hot air injection plate 530 is spaced apart by a certain distance from a surface on which a processing pattern of the lead tab 110 is defined.

In an embodiment of the present disclosure, since the upper surface processing pattern 310 and the lower surface processing pattern 320 are disposed on an upper surface and a lower surface of the lead tab 110, respectively, the stabilization unit 500 needs to provide heat with a certain temperature or higher toward both the upper surface processing pattern 310 and the lower surface processing pattern 320 to provide the oxidation film 401 on the upper and lower surfaces on which the upper surface processing pattern 310 and the lower surface processing pattern 320 are defined.

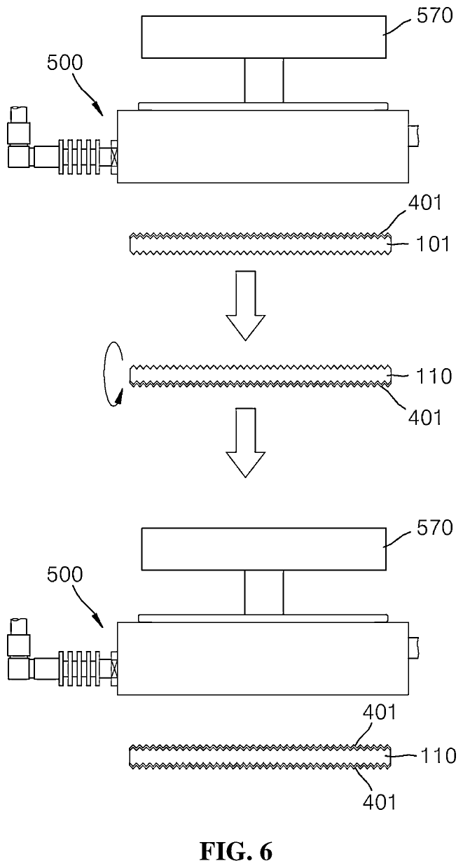

To do so, in an embodiment of the present disclosure, as illustrated in FIG. 6, operation S400 may sequentially include, for example, providing the oxidation film 401 to the upper surface processing pattern 310 by providing high temperature heat toward the upper surface processing pattern 310 of the lead tab 110, reversing the lead tab 110 upside down by 180 degrees through the lead tab inversion portion 330, and then, providing the oxidation film 401 on the lower surface processing pattern 320 by applying high temperature heat toward the lower surface processing pattern 320 of the lead tab 110.

In this case, the stabilization unit 500 may be provided as one unit in an upper or lower direction toward the lead tab 110.

On the other hand, as illustrated in FIG. 3, operation S400 may include providing the oxidation film 401 simultaneously on the upper surface processing pattern 310 and the lower surface processing pattern 320 of the lead tab 110.

In this case, as shown in FIG. 3, one stabilization unit 500 may be disposed both above and below the lead tab 110. This pair of stabilization units 500 is configured so that the hot air injection plate 530 may move closer to or away from a surface of the lead tab 110 as described above.

Accordingly, when the lead tab 110 is completely transferred to a stabilization work area to perform a stabilization process in a state of being gripped by the lead tab reversing portion 330, the hot air injection plate 530 of the pair of stabilization units 500 arranged both above and below of the lead tab 110 may be arranged to be in contact with the surface of the lead tab 110 or be spaced apart from the surface of the lead tab 110 by a certain distance. Accordingly, the stabilization operation may be performed using the contact or non-contact method as described above.

As such, when an oxidation film is defined simultaneously on an upper surface processing pattern and a lower surface processing pattern of a lead tab, time needed for a stabilization process may be further reduced, thereby increasing overall manufacture efficiency.

In an embodiment of the present disclosure, after the oxidation film 401 is provided on the upper and lower surfaces of the lead tab 110, the lead tab 110 on which the oxidation film 401 is provided is cooled through the post-processing unit 600 (S500).

In the present disclosure, a process of cooling the lead tab 110 to a certain temperature or below is performed before injecting a liquid adhesive material to be described below. Thus, when a process of injecting the liquid adhesive material on a surface of the lead surface 110 is performed, the liquid adhesive material may not be evaporated but may be in a stably applied state.

In an embodiment of the present disclosure, the post-processing unit 600 cools the lead tab 110 on which the oxidation film 401 is provided. As an example, low-temperature air may be blown to the surface of the lead tab 110 to perform the cooling.

As illustrated in FIG. 3, the post-processing unit 600 includes a compressed air providing portion 610 connected to an air compressor, etc. to provide compressed air, and a nozzle portion 620 connected to the compressed air providing portion 610 to inject low-temperature compressed air to outside. Here, the nozzle portion 620 may be configured to have a structure in which a distance from the surface of the lead tab 110 may be freely adjusted, or may be connected to be moved close to or apart from the surface of the lead tab 110 by a separate reciprocating movement structure portion (not shown) located in the compressed air providing portion 610.

In addition, although not illustrated in detail in the drawing, the post-processing unit 600 may cool the surface of the lead tab 110 by bringing a cooling body (not shown) having a low temperature into contact with the surface of the lead tab 110. Here, the cooling body (not shown) may be applied as, for example, a thermoelectric device having a low-temperature heating surface, an evaporator configured to provide a low temperature by refrigerant phase change to apply a low temperature to a peripheral space, etc.

Additionally, although not illustrated in detail in the drawing, the post-processing unit 600 may cool the surface of the lead tab 110 by injecting low-temperature water thereto.

As such, in the present disclosure, a surface of the lead tab 110 may be cooled by injecting low-temperature air or low-temperature water toward the surface of the lead tab 110 from a location apart from the lead tab 110, or bringing a cooling body (not shown) having a low temperature into contact with the surface of the lead tab 110.

In an embodiment of the present disclosure, the upper surface processing pattern 310 and the lower surface processing pattern 320 are disposed on an upper surface and a lower surface of the lead tab 110, respectively, and as described above, both the upper surface and the lower surface of the lead tab 110 are heated to a certain temperature or above by the stabilization unit 500. Thus, the stabilization unit 500 needs to provide a low temperature toward the upper surface processing pattern 310 and the lower surface processing pattern 320 to cool both the upper and lower surfaces of the lead tab 110 on which the upper surface processing pattern 310 and the lower surface processing pattern 320 are defined.

To do so, in the embodiment of the present disclosure, although not illustrated in detail in the drawing, similarly to a stabilization operation for providing the oxidation film 401, operation S500 may include, as an example, providing a low temperature toward the upper surface processing pattern 310 of the lead tab 110 to cool an upper surface portion of the lead tab 110 on which the upper surface processing pattern 310 is defined, then, reversing the lead tab upside down by 180 degrees through the lead tab reversing portion 330, and then sequentially cooling a lower surface portion of the lead tab 110 on which the lower surface processing pattern 320 is defined.

In this case, the post-processing unit 600 may be provided as one unit above or below the lead tab 110.

On the other hand, as illustrated in FIG. 3, in operation S500, a lower side and an upper side of the lead tab 110 may be simultaneously cooled.

In this case, as shown in FIG. 3, one post-processing unit 600 may be disposed both above and below the lead tab 110. This pair of stabilization units 600 may be configured so that the nozzle portion 620 moves closer to or away from a surface of the lead tab 110 as described above.

Accordingly, when the lead tab 110 is completely transferred to a post-processing work area to perform a cooling process (post-processing) on the lead tab 110 in a state of being gripped by the lead tab reversing portion 330, low-temperature compressed air may be injected from the nozzle portion 620 of the pair of post-processing units 600 disposed both above and below the lead tab 110, respectively, toward upper and lower surfaces of the lead tab 110 simultaneously to cool the upper and lower surfaces of the lead tab 110.

As such, when the upper and lower surfaces of the lead tab 110 are cooled simultaneously, time needed for the post-processing process (a process of cooling the lead tab) may be further reduced, thereby increasing overall manufacture efficiency.

The post-processing unit 600 may be provided as one unit above or below the lead tab 110, or provided both above and below the lead tab 110, both in a case when the post-processing unit 600 injects low-temperature water to cool the lead tab 110 and in a case when a cooling body (not shown) having a low temperature comes in contact with a surface of the lead tab 110 to cool the lead tab 110.

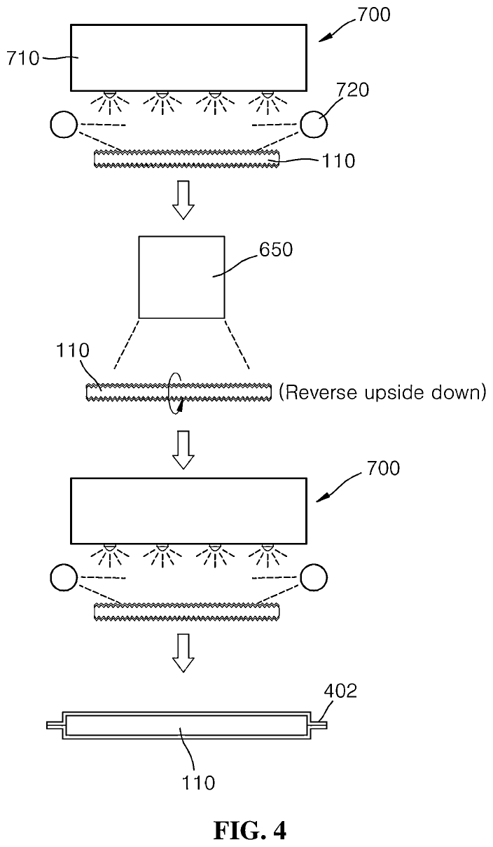

Then, as illustrated in FIGS. 1 and 4, a liquid adhesive material as an adhesive is injected on a surface of the oxidation film 401 to attach the sealant film 402 to upper and lower processing pattern portions of the lead tab 110 (S600).

In operation S600, an adhesive layer is defined by applying a polyvinyl alcohol (PVA) adhesive aqueous solution to the surface of the lead tab 110 so that the sealant film 402 may be easily adhered to the surface of the lead tab 110.

Here, the adhesive layer may be coated by applying, to the surface of the lead tab 110, a polyvinyl alcohol adhesive aqueous solution containing a mixed solution of a polyvinyl alcohol resin and a curing agent, and deionized (DI) water at a predetermined weight ratio.

The apparatus configured to manufacture a lead tab for a secondary battery according to an embodiment of the present disclosure includes an adhesive material injection unit 650 configured to inject a liquid adhesive material, i.e., a PVA adhesive aqueous solution onto a surface of the oxidation film 401 provided on the upper surface processing pattern 310 and the lower surface processing pattern 320 of the lead tab 110.

The adhesive material injection unit 650 includes a tank accommodating the PVA adhesive aqueous solution and a nozzle configured to receive the PVA adhesive aqueous solution from the tank and inject the PVA adhesive aqueous solution to the surface of the lead tab 110. The adhesive material injection unit 650 may further include a separate nozzle moving portion capable of moving the nozzle closer to or away from the surface of the lead tab 110.

Then, the liquid adhesive material as an adhesive injected on the surface of the oxidation film 401 is cured and dried (S700).

In operation S700, the PVA adhesive material is cured and dried by blowing high-temperature hot air as well as radiating ultraviolet rays to the surface of the lead tab 110. In detail, a PVA adhesive among the liquid PVA adhesive aqueous solution is cured by radiating ultraviolet rays, and hot air is blown to quickly dry moisture in the liquid PVA adhesive aqueous solution is by blowing hot air. Therefore, when operation S700 is completed, only a PVA adhesive layer that has been cured is disposed on the surface of the oxidation film 401 of the lead tab 110.

In an embodiment of the present disclosure, the radiation of the ultraviolet rays and the blowing of the hot air may be performed simultaneously, thereby enabling a curing and drying process of the PVA adhesive aqueous solution to proceed quickly.

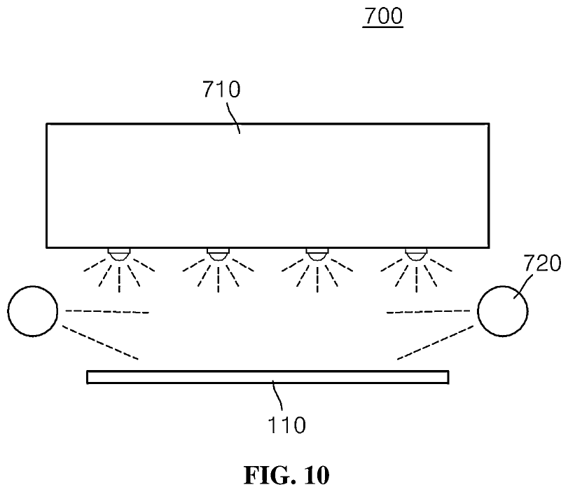

As illustrated in FIGS. 4 and 10 to 12, the apparatus configured to manufacture a lead tab for a secondary battery according to an embodiment of the present disclosure includes a curing and drying unit 700 configured to cure and dry the PVA adhesive material injected onto the upper and lower surfaces of the lead tab 110 through the adhesive material injection unit 650. The curing and drying unit 700 dries moisture to provide the PVA adhesive layer in a cured stated on the surface of the oxidation film 401.

As illustrated in FIGS. 4 and 10 to 12, the curing and drying unit 700 includes an ultraviolet radiation portion 710 equipped with an ultraviolet light-emitting diode (LED) lamp configured to radiate ultraviolet rays, a hot-air drying portion 720 capable of injecting hot air having a certain temperature or above, a fixed block 727 to which the ultraviolet radiation portion 710 and the hot-air drying portion 720 are fixed, a base 726, and a lifting/lowering movement portion 728 equipped on the base 726 to lift/lower the fixed block 727. Here, a cylinder, etc. may be applied as the lifting/lowering movement portion 728.

The ultraviolet radiation portion 710 is positioned above the lead tab 110 and radiates ultraviolet rays to an upper surface of the lead tab 110 to cure the PVA adhesive in the liquid PVA adhesive aqueous solution.

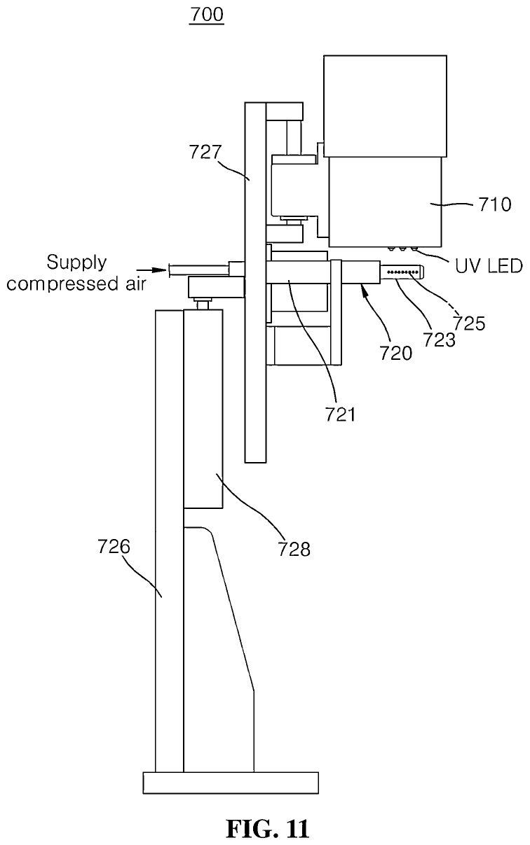

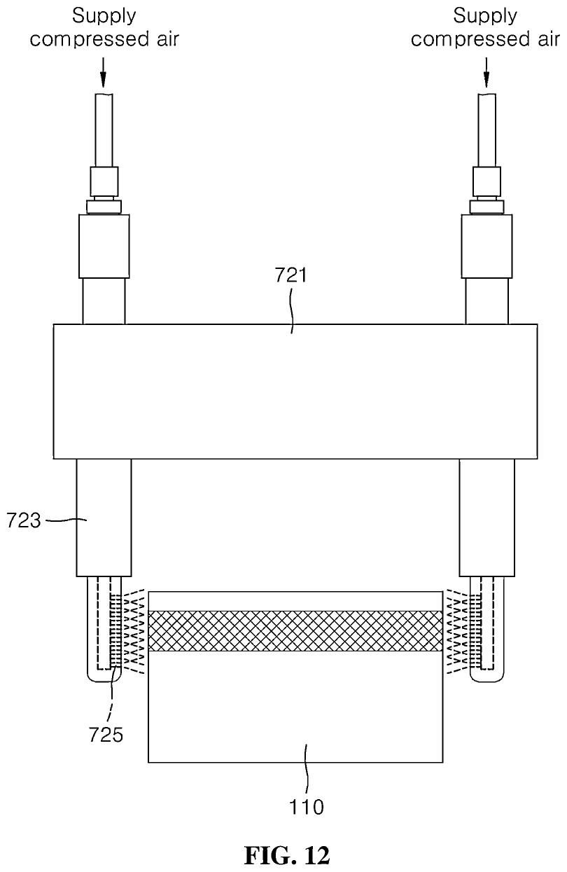

As illustrated in FIGS. 11 and 12, the hot-air drying unit 720 includes a heater block 721 having a built-in heater and configured to develop a high temperature according to heat generated by the heater, and a compressed air injection pipe portion 723 coupled to the heater block 721 to receive high temperature heat of the heater block 721 and configured to receive compressed air from outside and inject the compressed air toward the lead tab 110.

In an embodiment of the present disclosure, the compressed air injection pipe portion 723 may be made of a material with an excellent heat transfer rate, such as copper, aluminum, or the like to sufficiently receive the high temperature heat of the heater block 721, and then, heat compressed air flowing along a flow path inside the compressed air injection pipe portion 723.

The compressed air injection pipe portion 723 may be provided in plurality. When the compressed air injection pipe portion 723 is provided in a pair, the pair of the compressed air injection pipe portions 723 may be positioned near both left and right sides of the lead tab 110 in a width direction, respectively. A plurality of micro-injection holes 725 are disposed near end portions of the pair of the compressed air injection pipe portions 723 to inject high-temperature compressed air toward the lead tab 110.

In an embodiment of the present disclosure, operations S600 and S700 may be performed repeatedly. In detail, a liquid PVA adhesive material may be injected to the oxidation film 401 on the upper surface of the lead tab 110, and then, completely cured and dried. Thereafter, the lead tab 110 is reversed upside down by 180 degrees, and then, the liquid PVA adhesive material may be injected on the oxidation film 410 provided on a lower surface of the lead tab 110, and then, completely cured and dried.

As such, when multiple processes are completed, the sealant film 402 is attached to the upper and lower surfaces of the lead tab 110.

While the present disclosure has been illustrated and described with reference to embodiments for illustrating the principles of the present disclosure, the present disclosure is not limited to the embodiments set forth herein; Rather, it may be understood by one of ordinary skill in the art that various changes and modifications thereof may be made without departing from the spirit and scope of the present disclosure.

| | |
|---|---|
| 100: Original sheet of a lead tab | 101: Supply roll |
| 110: Lead tab | 200: Cutting unit |
| 300: Marking unit | 310: Upper surface processing pattern |
| 320: Lower surface processing pattern | 330: Lead tab reversing portion |
| 340: Marking portion | 401: Oxidation film |
| 402: Sealant film | 500: Stabilization unit |
| 501: Stabilization body | 504: Heater |
| 506: Air flow path | 507: First air flow path |
| 508: Second air flow path | 509: Third air flow path |
| 520: Heat conductive ball | 530: Hot air injection plate |
| 531: Hot air injection hole | 540: Air supply socket |
| 542: Heat dissipation fin | 550: Flow cap |
| 551: Flow cap plate | 553: First through hole |
| 554: connection portion | 556: Second through hole |
| 557: Third through hole | 560: Cover block |
| 570: Stabilization body transfer portion | 600: Post-processing unit |
| 620: Nozzle portion | 650: Adhesive material injection unit |
| 700: Curing and drying unit | 710: Ultraviolet radiation portion |
| 720: Hot-air drying portion | 721: Heater block |
| 723: Compressed air injection pipe portion | 725: Micro-injection hole |
| 727: Fixed block | 728: Lifting/lowering movement portion |

What is claimed is:

1. An apparatus configured to manufacture a lead tab for a second battery, the apparatus comprising:
a marking unit configured to define a processing pattern on a processing area set on each of an upper surface and a lower surface of an original sheet of the lead tab or the lead tabs; and
a stabilization unit configured to provide an oxidation film to the upper and lower surfaces of the original sheet of the lead tab or each of the lead tabs, the upper and lower surfaces having the processing pattern defined thereon, respectively, by applying heat with a certain temperature or above to each of the original sheet of the lead tab or the lead tabs having the processing pattern defined on the upper and lower surfaces, respectively.

2. The apparatus of claim 1, further comprising a post-processing unit configured to cool each of the sheet-shaped lead tabs on which the oxidation film is provided.

3. The apparatus of claim 1, wherein the stabilization unit comprises:
a stabilization body equipped with a hot air injection plate at one side, the hot air injection plate having a plurality of hot air injection holes disposed therein;
a heater mounted in the stabilization body;
at least one air flow path disposed in the stabilizing body and configured to define a path to cause compressed air provided from outside to flow toward the plurality of hot air injection holes; and
a plurality of heat conductive balls accommodated in the at least one air flow path and made of a heat-conductive material.

4. The apparatus of claim 3, wherein the plurality of heat conductive balls are made of an alumina or copper material.

5. The apparatus of claim 3, wherein a flow cap is installed in the at least one air flow path, the flow cap being configured to limit an area of the at least one air flow path in which the plurality of heat conductive balls are accommodated and prevent the flowing of the compressed air from being interrupted by the plurality of heat conductive balls.

6. The apparatus of claim 3, wherein the hot air injection plate is arranged to be in direct contact with the upper and lower surfaces of the original sheet of the lead tab or each of the lead tabs, the upper and lower surfaces having the processing pattern defined thereon.

7. The apparatus of claim 2, wherein the post-processing unit cools the upper and lower surfaces of the original sheet of the lead tab or each of the lead tabs by blowing low-temperature air onto the upper and lower surfaces or by injecting water having a low temperature to the upper and lower surfaces.

8. The apparatus of claim 2, wherein the post-processing unit cools the upper and lower surfaces of the original sheet of the lead tab or each of the lead tabs by bringing a cooling body having a low temperature in contact with the upper and lower surfaces.

9. A method for manufacturing a lead tabs for a secondary battery, the method comprising:
(a) supplying an original sheet of the lead tab or the lead tabs;
(b) defining a processing pattern on each of an upper surface and a lower surface of the original sheet of the lead tab or each of the lead tabs by radiating laser light to a processing area set on each of the upper surface and the lower surface;
(c) providing an oxidation film to the upper and lower surfaces on which the processing pattern is defined, by applying heat with a certain temperature or above to the original sheet of the lead tab or each of the lead tabs having the processing pattern defined on the upper and lower surfaces, respectively.

10. The method of claim 9, wherein operation (a) comprises unwinding and supplying an original sheet of the lead tab wound in a roll state or cutting the original sheet of the lead tab continuously supplied, at intervals, to be divided into sheet-shaped lead tabs and supplying the sheet-shaped lead tabs.

11. The method of claim 9, further comprising (d) after operation (c), cooling the original sheet of the lead tab or each of the sheet-shaped lead tabs on which the oxidation film is provided.

12. The method of claim 9, wherein operation (c) is performed by a hot air injection plate being arranged to be in direct contact with the upper and lower surfaces of the original sheet of the lead tab or each of the lead tabs, wherein the hot air injection plate provides heat at a temperature above a certain level to the upper and lower surfaces having the processing pattern defined thereon.

13. The method of claim 11, wherein operation (d) comprises blowing low-temperature air or spraying water at low temperature onto the surface of the original sheet of the lead tab or each of the lead tabs to cool.

14. The method of claim 11, wherein operation (d) comprises contacting the surface of the original sheet of the lead tab or each of the lead tabs with a cooling body having a low temperature to cool.
